(19) United States
(12) Patent Application Publication
(10) Pub. No.: US 2015/0338986 A1
(43) Pub. Date: Nov. 26, 2015

(54) ELECTRONIC DEVICE, CONTENTS DISPLAY METHOD, AND CONTENTS DISPLAY PROGRAM

(71) Applicant: Sharp Kabushiki Kaisha, Osaka-shi, Osaka (JP)

(72) Inventor: Hiroyuki YOKOHATA, Osaka-shi (JP)

(21) Appl. No.: 14/655,394

(22) PCT Filed: Feb. 4, 2014
(86) PCT No.: PCT/JP2014/052565

§ 371 Date: Jun. 25, 2015

(30) Foreign Application Priority Data
Feb. 26, 2013 (JP) 2013-035956

(51) Int. Cl. G06F 3/041

(52) U.S. Cl. CPC G06F 3/0416

(57) ABSTRACT

A display unit displays contents including a plurality of list items, an operation input unit accepts an operation input, a position detection unit detects at least two positions at which the operation input unit accepts an operation input, and a display control unit controls at least a part of an information amount of contents to be displayed in a region including at least two positions detected by the position detection unit, the control being performed based on a change amount of a distribution of the at least two positions.

### TECHNICAL FIELD

The present invention relates to an electronic device, a contents display method, and a contents display program.

The subject application claims priority based on the patent application No. 2013-035956 filed in Japan on Feb. 26, 2013 and incorporates by reference herein the contents thereof.

### BACKGROUND ART

Electronic devices such as multifunction mobile telephone handsets display an image and have a touch panel that accepts operation inputs from a user. In these electronic devices, contents having a list structure might be displayed.

Such contents are, for example in an e-mail list screen of an electronic mail function, in which the various items of transmission and receiving information of the e-mail, for example, sender information, a transmission timestamp or a receiving timestamp, and the subject, which are displayed as a list. By changing settings, a user can switch the information amount of contents to be displayed, for example, between the subject, the subject and sender information, and the subject, sender information, and body. Also, in a share list displayed on a website provided by an SNS (social networking service), the various items constituting the share list include the sender information, the share time, a comment, and a photograph or the like. However, the amount of information of each item displayed at one time is fixed and cannot be changed by the user.

In an e-mail list screen, to switch the amount of information of each item, a troublesome operation such as displaying a separate setting screen and selecting a setting item or the like might be required each time. When making operations related to settings, because attention is drawn away from the displayed contents, there is a risk of making incorrect operations related to the contents display. Also, the share list might uniformly display information not required by a user or information of little concern to the user, of which items having a large amount of information might occupy the major portion of the screen. For this reason, the user might not be able to view each item constituting list-structured contents (that is, it might not serve as a list), and might not be able to view a desired item.

Given the above, in the apparatus for managing lists described in Patent Document 1, a proposal is made of specifying an entire list as the selected range for changing the list structure and of expanding or contracting a list structure by dragging caused by a multi-touch when a list is displayed on a touch screen and a multi-touch is input at two or more points within a certain time.

### PRIOR ART DOCUMENT

### Patent Document

[Patent Document 1] Japanese Translation of PCT International Application Publication No. JP-T-2012-504837

### SUMMARY OF THE INVENTION

### Problem to Be Solved by the Invention

However, because the apparatus for managing a list described in Patent Document 1 minimally requires a certain amount of time for the intent of the user to be reflected in processing in order to determine whether or not a multi-touch has been input for a certain amount of time, ease of operation has been lost. Also, because the apparatus for managing a list determines whether or not the entire list is specified as the selecting range each time a multi-touch is made, a single operation cannot make a hierarchal selection of the selection range. For this reason, the user could not smoothly manipulate the amount of information to be displayed. Also, the target of processing by the method for managing a list structure described in Patent Document 1 is just a list structure, it does not process the amount of contents information displayed.

The present invention has been made in consideration of the above-noted points, and provides an electronic device and a contents display control method capable of intuitive manipulation of the amount of information of displayed contents.

### Means to Solve the Problem

The present invention is made to solve the above-described problem, and one aspect of the present invention is an electronic device including: a display unit that displays contents including a plurality of list items; an operation input unit that accepts an operation input; a position detection unit that detects at least two positions at which the operation input unit accepts an operation input; and a display control unit that controls at least a part of an information amount of contents to be displayed in a region including at least two positions detected by the position detection unit, the control being performed based on a change amount of a distribution of the at least two positions.

### Effect of the Invention

According to an embodiment of the present invention, it is possible to intuitively manipulate the amount of information of displayed contents.

### BRIEF DESCRIPTION OF THE DRAWINGS

FIG. 1 is a simplified drawing showing the outer appearance of an electronic device 1 according to a first embodiment of the present invention.

FIG. 2 is a simplified block diagram showing the constitution of the electronic device 1 according to the present embodiment.

FIG. 3 is a conceptual drawing showing an example of list-structured contents.

FIG. 4 is a flowchart showing the contents display processing according to the present embodiment.

FIG. 5 is a drawing showing a contents display example (1).

FIG. 6 is a drawing showing a contents display example (2).

FIG. 7 is a drawing showing a contents display example (3).

FIG. 8 is a drawing showing a contents display example (4).

FIG. 9 is a drawing showing a contents display example (5).

FIG. 10 is a drawing showing a contents display example (6).

FIG. 11 is a flowchart showing the contents display processing according to a second embodiment of the present invention.

FIG. 12 is a drawing showing a contents display example (7).

FIG. 13 is a drawing showing a contents display example (8).

FIG. 14 is a drawing showing a contents display example (9).

FIG. 15 is a drawing showing a contents display example (10).

FIG. 16 is a drawing showing a contents display example (11).

FIG. 17 is a drawing showing a contents display example (12).

### EMBODIMENTS FOR CARRYING OUT THE INVENTION

### First Embodiment

The first embodiment of the present invention will be described below, with references made to the drawings.

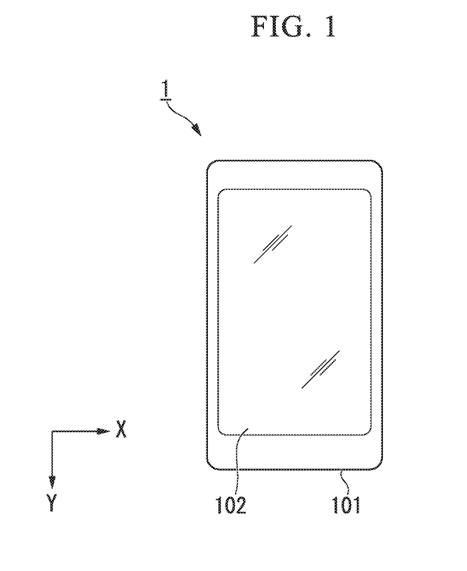

FIG. 1 is a simplified drawing showing the outer appearance of the electronic device 1 according to the present embodiment.

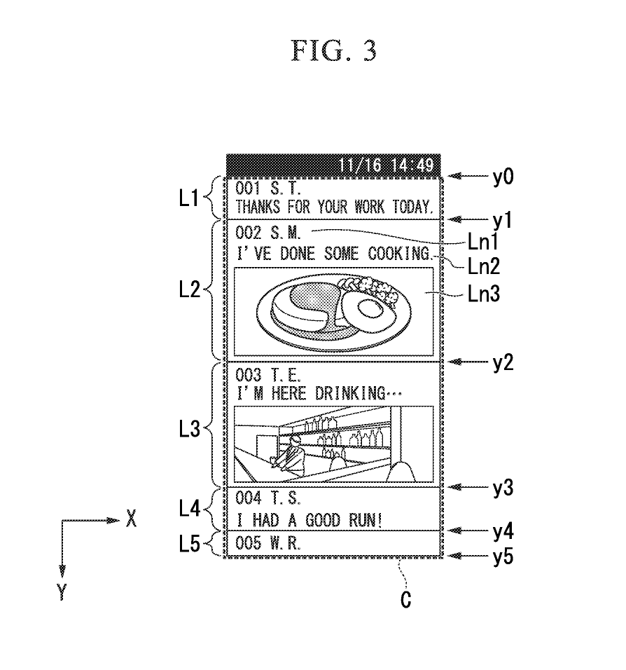

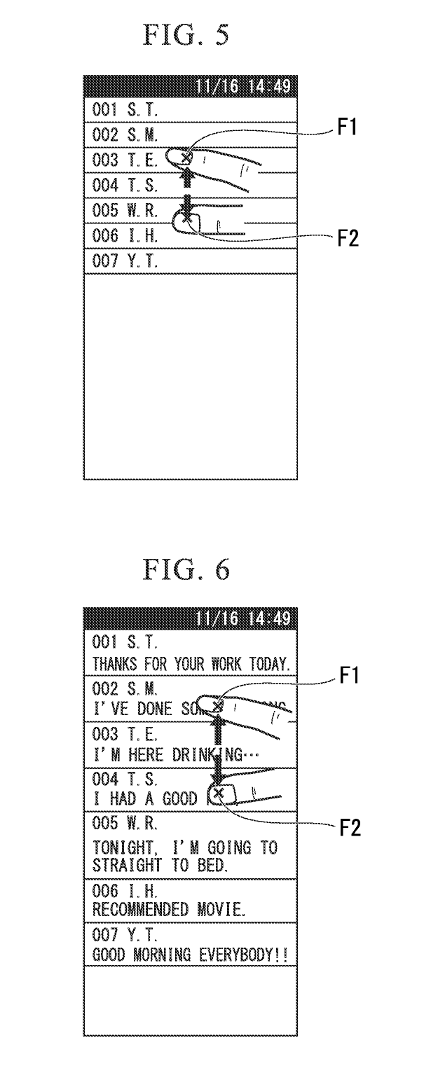

FIG. 1 is a plan view of the electronic device 1 according to the present embodiment, the right side with respect to the drawing being the X direction (horizontal direction) and the downward direction being the Y direction (vertical direction). The directions indicated by the X direction and the Y direction are the same in FIG. 3, FIG. 5 to FIG. 10 and FIG. 12 to FIG. 17.

The electronic device 1 is, for example, a multifunction mobile telephone handset (including a so-called smartphone), a tablet terminal device, a personal computer, or an electronic book reading terminal. The electronic device 1 is constituted to include an enclosure 101 and a touch panel 102. The enclosure 101 houses the various constituent elements of the electronic device 1 and holds them together with the touch panel 102.

(Constitution of the Electronic Device 1)

Next, the constitution of the electronic device 1 of the present embodiment will be described.

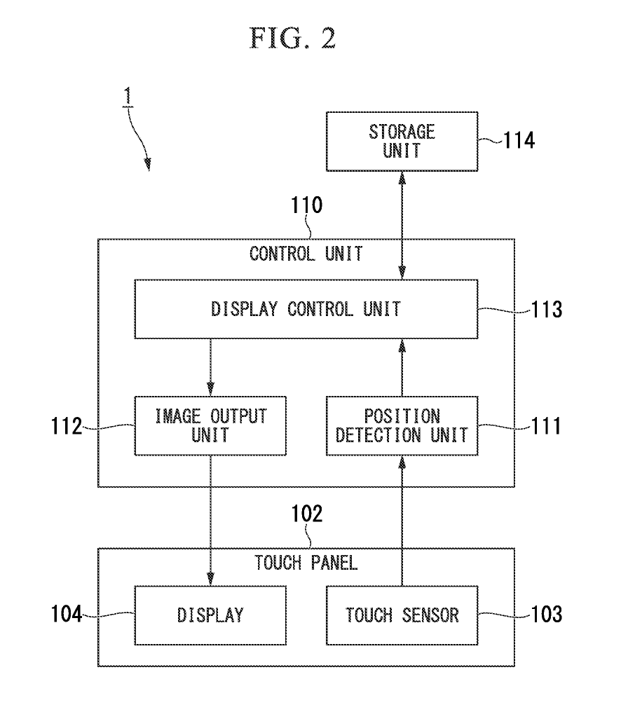

FIG. 2 is a simplified block diagram showing the constitution of the electronic device 1 according to the present embodiment.

The electronic device 1 is constituted to include the touch panel 102, the control unit 110, and the storage unit 114, of which the control unit 110 and the storage unit 114 are housed in the enclosure 101 (FIG. 1).

The touch panel 102 covers the major portion of the surface of the electronic device 1 and is constituted to include a touch sensor 103 and a display (display unit) 104.

The touch sensor 103 detects the position of contact by an operation actuator (for example, a user index finger) on the surface thereof, generates position information indicating the detected position, and outputs the generated position information to the position detection unit 111. In order to sense the position of contact by an operation actuator, the touch sensor 103 has a plurality of elements (for example, capacitive sensors) arranged with a uniform spacing on one flat surface, and detects whether or not an operation actuator is contacting each element. That is, the position information indicates the position of each element that detects contacting by an operation actuator.

The front surface of the display 104 makes contact with the rear surface of the touch sensor 103. The display 104 displays an image based on an image signal input from the image output unit 112. The display 104 is, for example, a liquid display panel and or an organic EL (electroluminescence) display panel. The display 104 may be separate from the touch sensor 103 or may be integrated together therewith.

The control unit 110 controls the operation of the electronic device 1. The control unit 110 is constituted to include, for example, a control component such a CPU (central processing unit) and counter and can implement various functions by executing a program stored in a storage medium such as a ROM (read-only memory). Considering the aspects of these functions, the control unit 110 is constituted to include the position detection unit 111, the image output unit 112, and the display control unit 113.

The position detection unit 111 detects position information input from the touch sensor 103 every pre-established time interval (for example, 20 ms) and outputs the detected position information to the display control unit 113.

Because the contact region in which an operation actuator contacts the touch sensor 103 is generally broad, the position detection unit 111 calculates a representative point (for example, the center of gravity) representing the contact region indicated by the input position information. If there are a plurality of contact regions, the position detection unit 111 calculates the representative point for each of the contact regions. In this case, the position detection unit 111 distinguishes between each contact region by determining as a contact region a contiguous region occupied by a group of mutually neighboring elements that are touch sensor 103 elements that have detected touching by an operation actuator. The position detection unit 111 generates position information indicating the representative point of each contact region and outputs the position information to the display control unit 113.

The image output unit 112 outputs to the display 104 an image signal input from the display control unit 113.

The display control unit 113 reads out from the storage unit 114 an instruction image signal (for example, icon data) indicating application software (hereinafter, simply “applications”) stored in the storage medium thereof. The display control unit 113 outputs the read-out instruction image signal to the image output unit 112 and causes the display 104 to display an instruction image (for example, an icon) associated with the instruction image signal. By an operation actuator contacting a display region on the touch sensor 103 in which an instruction image is displayed, the application associated with that image is launched. That is, the display control unit 113 specifies the position indicated by the position information input from the position detection unit 111 and the application associated with the instruction image included in that display region, and starts the execution of the specified application. Applications include, for example, a web browser that displays on the display 104 information provided from a website connected to the Internet and e-mail consisting of messages received and transmitted with another electronic device via the Internet.

The display control unit 113 executes an application, reads list-structure contents from the storage unit 114, outputs read-out contents to the image output unit 112, and displays the read-out contents on the display 104. List-structured contents have an arrangement of a plurality of list items, and in the present embodiment mainly at least one of the list items may have information of a plurality of hierarchal levels. If the position information input from the position detection unit 111 indicates at least two positions (multi-touch), the display control unit 113 controls the information amount of the list-structured contents displayed in regions at least two positons based on the change amount of the distribution of those positions. In this case, the display control unit 113 controls the number of hierarchal levels to be displayed of the plurality of hierarchal levels of the list items, based on the change amount of the distribution (for example, spacing between fingers) of the at least two positions for at least a part (for example, the entire contents) of the contents. Examples of list-structured contents and contents display processing will be described later.

The storage unit 114 temporarily stores data used in processing by the control unit 110 and data generated by processing. The information stored in the storage unit 114 is, for example, list-structured contents, instruction image signals (icons and the like) indicating the above-described applications, and instruction image signals indicating applications. The storage unit 114 is, for example, a non-volatile memory such as a RAM (random-access memory).

(List-Structured Contents)

Next, an example of list-structured contents and an example of a share list provided from an SNS site will be described.

FIG. 3 is a conceptual drawing showing an example of list-structured contents.

In FIG. 3, the first line shows the current date, 11/16 (November 16) and the current time 14:49 (14 hours, 49 minutes). Directly therebelow, the contents display region C is indicated by a broken line. Five list items, L1 to L5, are arranged from top to bottom in the display region C.

Each of the list items includes information of one or a plurality of hierarchal levels. The hierarchal levels are called level 1, 2, 3, (or Ln1, Ln2, Ln3) and so on. In the present embodiment, different data types are allocated to each hierarchal level. In this case, the higher is the hierarchal level, the greater is the amount of information, and the greater it becomes, the more types of data to be expected may be allocated. The lower is the hierarchal level, the higher is the priority of types of the data to be displayed that may be allocated. In this example, the item number (002, and the like) and the sharer information (S, M, and the like) are allocated to Ln1, a comment (“I've done cooking!” or the like) is allocated to Ln2, and image data (photograph showing the food or the like) is allocated to Ln3. In the description to follow, individual list items might be identified by their item numbers.

Some list items, such as list items L1, L4, and L5, might not have all of Ln1 to Ln3, and may have Ln2, Ln3 or neither. The number N of hierarchal levels of data is not restricted to three hierarchal levels and may be two or greater than three hierarchal levels. Of N hierarchal levels, the hierarchal levels of data display on the display 104 will be called the number of displayed hierarchal levels Nd. In this case, the information of Ln1 to LnNd is displayed. In the example shown in FIGS. 3, y0 to y4 indicate the respective Y coordinates of the upper edges of the list items L1 to L5, and y1 to y5 indicate the respective Y coordinates of the lower edges of the list items L1 to L5.

(Contents Display Processing)

Next, an example of contents display processing according to the present embodiment will be described.

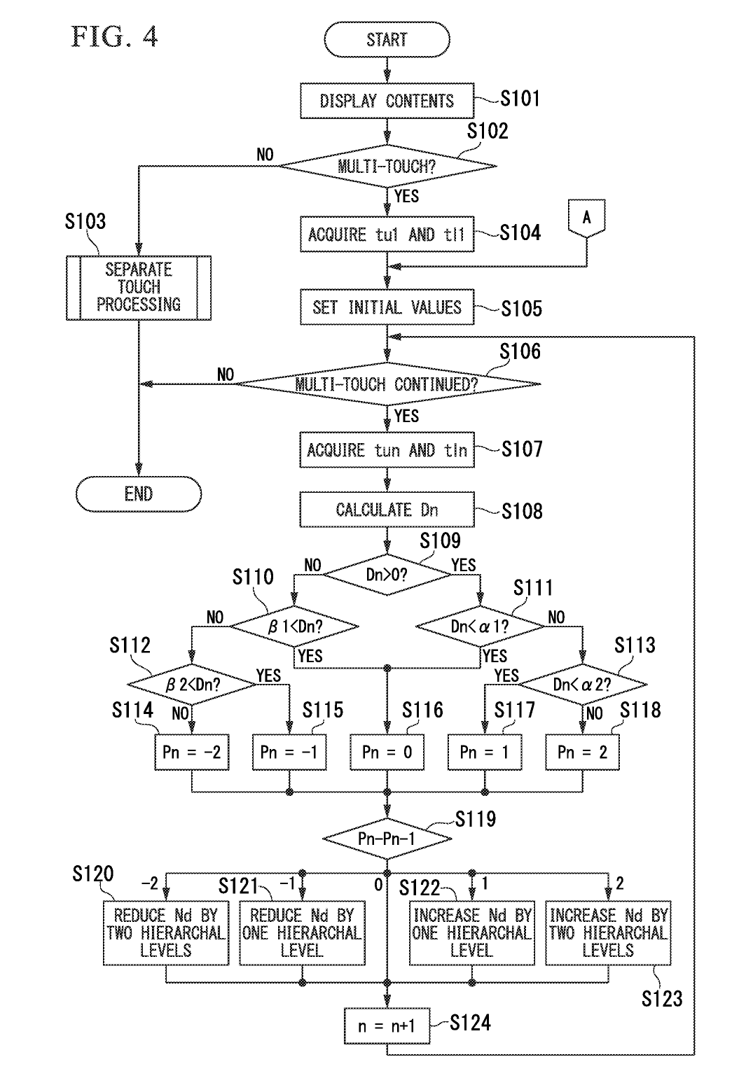

FIG. 4 is a flowchart showing the contents display processing according to the present embodiment.

The processing shown in FIG. 4 controls the overall amount of information of the list items included in the contents to be displayed in accordance with operation input, over the displayable range in the contents display region C (FIG. 3).

(Step S101) The display control unit 113 reads out list-structured contents from the storage unit 114 and displays the read-out contents on the display 104. After that, processing proceeds to step S102.

(Step S102) The position detection unit 111 detects position information from the touch sensor 103 indicating positions at which an operation actuator makes contact and calculates positions (touch position) of points representative of each contact region indicated by the detected position information. The display control unit 113 determines whether or not the number of positions of representative points detected by the position detection unit 111 is greater than one (multi-touch). If the determination is that it is greater than one (YES at step S102), processing proceeds to step S104). If the determination is that the number is not greater than one (NO at step S102), processing proceeds to step S103.

(Step S103) The display control unit 113 performs separate touch processing. Separate touch processing is processing that changes the display format of contents if the number of positions (representative points) indicated by the position information input from the position detection unit 111 is one, this being for example scrolling and display of details.

The display control unit 113 performs scrolling when a flick operation is detected. In this case, if the position information is input continuously for more than a pre-established time (for example 0.2 second) and the position (Y coordinate) indicated by the position information has changed from the initial touch position, the display control unit 113 determines that a flick operation has been made. The initial touch position is the position indicated by the position information at the point in time when the input from the position detection unit 111 starts, that is, from the starting point of contact by the operation actuator with the touch sensor 103. The display control unit 113 moves the display region of a displayed list item (or a list item to be displayed) in the Y direction by the amount of change in the Y direction from the initial touch position.

When a click operation is detected in the display region of one of the displayed list items, the display control unit 113 displays details regarding the list item displayed in that display region.

In this case, if the display control unit 113 determines that the position information was input from the position detection unit 111 for a time shorter than a pre-established time, it detects the list item displayed in a display region including the position indicated by the input position information. The display control unit 113 reads out from the storage unit 114 information of the number of the displayed hierarchal level Nd (for example the hierarchal level N) pre-established regarding the detected list item. As described above, the displayed hierarchal level number Nd is a hierarchal level number of information to be displayed on the display 104 for each list item. The displayed hierarchal level number Nd can be an integer greater than 0 and less than or equal to the number of hierarchal levels N. There are cases in which a list item has information for a number of hierarchal levels fewer than the displayed number of hierarchal levels Nd. For such list items, the information for all the hierarchal levels that the list item has is read out from the storage unit 114. The display control unit 113 outputs the read-out information to the image output unit 112 and causes display of the information on the display 104. After that, the processing ends.

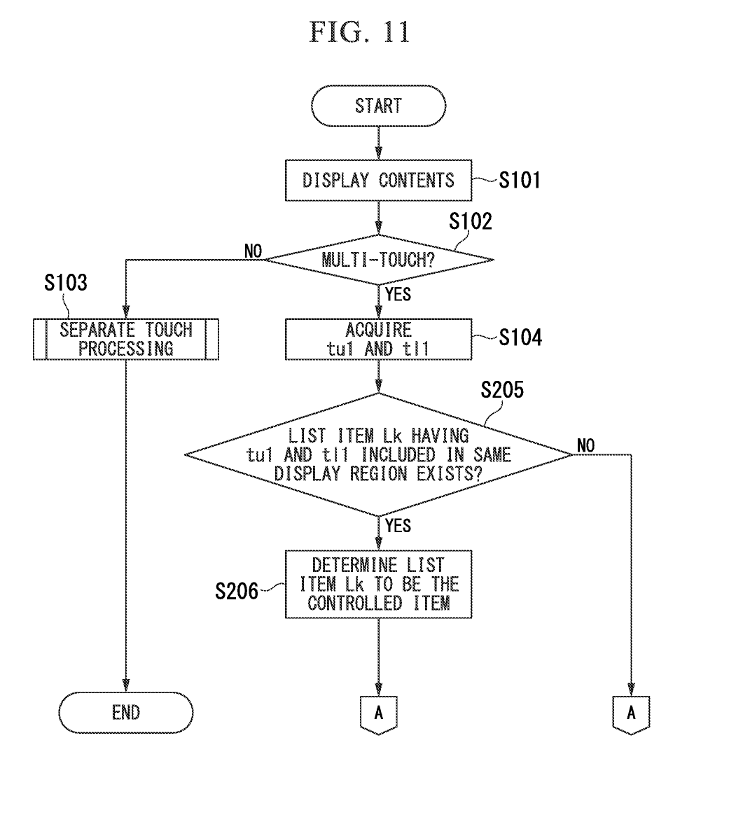

(Step S104) The display control unit 113 acquires a plurality of (for example, two) initial touch positions tu1 and tl1 indicating, respectively, the minimum (upper-side) Y coordinate and the maximum (lower-side) Y coordinate of the plurality of initial touches. The absolute value |tu1−tl1| of the difference value tu1−tl1 indicates the size of the distribution (spacing) of the initial touch positions. After that, processing proceeds to step S105. The joining element A directed toward step S105 indicates that step S105 is performed after steps S205 and S206 shown in FIG. 11. Therefore, the joining element A does not influence the contents display processing of the present embodiment.

(Step S105) The display control unit 113 sets the initial values of the number of loop iterations n and the number of displayed hierarchal levels Nd (for example, n=2 and Nd=1) and the initial value of P1 (for example, P1=0) of the reference hierarchal level number Pn. The reference hierarchal level number Pn is a value indicating the amount of change to a candidate of the displayed hierarchal level number Nd at the current loop n, referenced to the initial displayed hierarchal level number Nd. After that, processing proceeds to step S106.

(Step S106) The display control unit 113 determines whether or not the number of representative points indicated by the position information detected by the position detection unit 111 continues as a plurality of points (multi-touch continuing). If the determination is that the multi-touch is continuing (YES at step S106), processing proceeds to step S107, otherwise (NO at step S106), the contents display processing according to the present embodiment ends.

(Step S107) The display control unit 113 acquires the touch positions tun and t1n in the current loop n. After that, processing proceeds to step S108.

(Step S108) The display control unit 113 calculates the change amount Dn in the current loop n, for example using Equation (1).

Dn=|tu1−tl1|−|tun−t1n| (1)

The change amount Dn indicated in Equation (1) indicates the amount of change of the distribution of the touch positions in the current loop n from distribution of the initial touch positions. After that, processing proceeds to step S109.

(Step S109) The display control unit 113 determines whether the change amount Dn is positive or negative. If the determination is positive (YES at step S109), processing proceeds to step S111. If the determination is negative (NO at step S109), processing proceeds to step S110.

(Step S110) The display control unit 113 determines whether or not the change amount Dn is larger than a pre-established negative threshold β1. This detects whether or not a pinch-out operation is made. A pinch-out operation is one in which the distribution of a plurality of operation actuators contacting the touch sensor 103 is broadened, for example, when the spacing between contacting two fingers increases. If the determination is that of bigger than the threshold β1 (YES at step S110), processing proceeds to step S116. In other cases (NO at step S110), processing proceeds to step S112.

(Step S111) The display control unit 113 determines whether or not the change amount Dn is smaller than a pre-established positive threshold α1. In this case, the relationship may be α1=−β1. This detects whether or not a pinch-in operation is made. A pinch-in operation is one in which the distribution of a plurality of operation actuators contacting the touch sensor 103 is narrowed, for example, when the spacing between contacting two fingers decreases. If the determination is that of smaller than the threshold α1 (YES at step S111), processing proceeds to step S116. In other cases (NO at step S111), processing proceeds to step S113.

(Step S112) The display control unit 113 determines whether or not the change amount Dn is larger than a pre-established threshold β2. The threshold β2 is a negative value smaller than the threshold β1. If the determination is larger than the threshold β2 (YES at step S112), processing proceeds to step S115). In other cases (NO at step S112), processing proceeds to step S114.

(Step S113) The display control unit 113 determines whether or not the change amount Dn is smaller than a pre-established threshold α2. The threshold α2 is a positive value larger than the threshold α1. In this case, the relationship may be α2=−β2. If the determination is smaller than the threshold α2 (YES at step S113), processing proceeds to step S117. In other cases (NO at step S113), processing proceeds to step S118.

(Step S114) The display control unit 113 establishes the reference hierarchal level number Pn as −2 in the current loop n. As noted in the following description, the reference hierarchal level number Pn is a larger value, the larger is the change amount Dn. After that, processing proceeds to step S119.

(Step S115) The display control unit 113 establishes the reference hierarchal level number Pn as −1 in the current loop n. After that, processing proceeds to step S119.

(Step S116) The display control unit 113 establishes the reference hierarchal level number Pn as 0 in the current loop n. After that, processing proceeds to step S119.

(Step S117) The display control unit 113 establishes the reference hierarchal level number Pn as 1 in the current loop n. After that, processing proceeds to step S119.

(Step S118) The display control unit 113 establishes the reference hierarchal level number Pn as 2 in the current loop n. After that, processing proceeds to step S119.

(Step S119) The display control unit 113 calculates the difference value Pn−Pn−1 of the reference hierarchal level number Pn−1 in loop n−1 from the immediately previous to the reference hierarchal level number Pn in the current loop n. When the difference value is −2, −1, 0, 1, and 2, processing proceeds to steps S120, S121, S124, S122, and S123, respectively.

(Step S120) The display control unit 113 reduces the current displayed hierarchal level number Nd by two hierarchal levels and causes display of the contents at the reduced displayed hierarchal level number Nd on the display 104. After that, processing proceeds to step S124.

(Step S121) The display control unit 113 reduces the current displayed hierarchal level number Nd by one hierarchal levels and causes display of the contents at the reduced displayed hierarchal level number Nd on the display 104. After that, processing proceeds to step S124.

(Step S122) The display control unit 113 increases the current displayed hierarchal level number Nd by one hierarchal levels and causes display of the contents at the increased displayed hierarchal level number Nd on the display 104. After that, processing proceeds to step S124.

(Step S123) The display control unit 113 increases the current displayed hierarchal level number Nd by two hierarchal levels and causes display of the contents at the increased displayed hierarchal level number Nd on the display 104. After that, processing proceeds to step S124.

(Step S124) The display control unit 113 increases (increments) the current loop number n by 1 and proceeds to step S106.

However, at steps S120 and S121, if there is a list item for which the current displayed hierarchal level number Nd is smaller than 1, the current displayed hierarchal level number Nd is established as a lower limit of, for example, 1. At steps S122 and S123, if there is a list item for which the current displayed hierarchal level number Nd is greater than the number of hierarchal levels N, the current displayed hierarchal level number Nd is established as an upper limit of, for example, N. The display control unit 113 displays the contents at each of the established displayed hierarchal level numbers Nd on the display 104.

Next, contents display examples will be described, using FIG. 5 to FIG. 10.

FIG. 5 to FIG. 10 show display examples (1) to (6) of the contents.

In the example shown in FIG. 5, seven list items 001 to 007 arranged in the Y direction are each displayed at one hierarchal level (level 1). The two × symbols F1 and F2 indicate representative points of two fingers contacting the touch sensor 103. In this example, the positions of the representative points F1 and F2 indicate the initial touch positions. The arrows pointing to the representative points F1 and F2 indicate the directions in which the representative points move. That is, these indicate that the spacing between the two fingers broadens.

The example shown in FIG. 6 is a display example when the change amount Dn is equal to or smaller than the negative threshold β1. In this case, information up to one hierarchal level greater than the case shown in FIG. 5 (levels 1 and 2) is displayed for each list item.

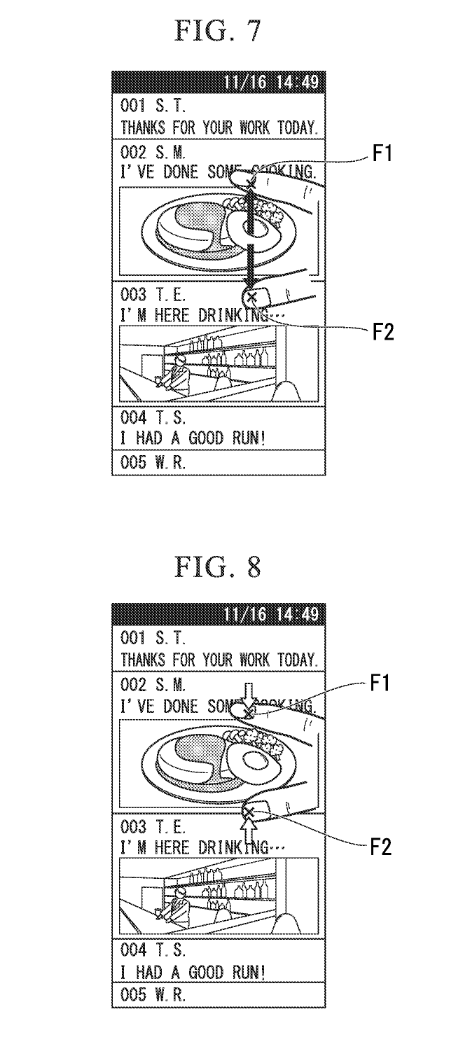

The example shown in FIG. 7 is a display example when the change amount Dn is equal to or smaller than the negative threshold β2. In this case, information up to two hierarchal levels greater than the case shown in FIG. 5 (levels 1 to 3) is displayed for each list item. However, because list items 001 and 004 do not include level 3 information, only level 1 and 2 information is displayed. Although list item 005 includes level Ln2 information, because the position at which the level Ln2 information should be displayed extends outside the display region C (FIG. 3), only level Ln1 information is displayed.

In FIG. 8, the same type of contents is displayed as in FIG. 7. In this example, the representative points F1 and F2 have started to move in directions that bring them close to each another.

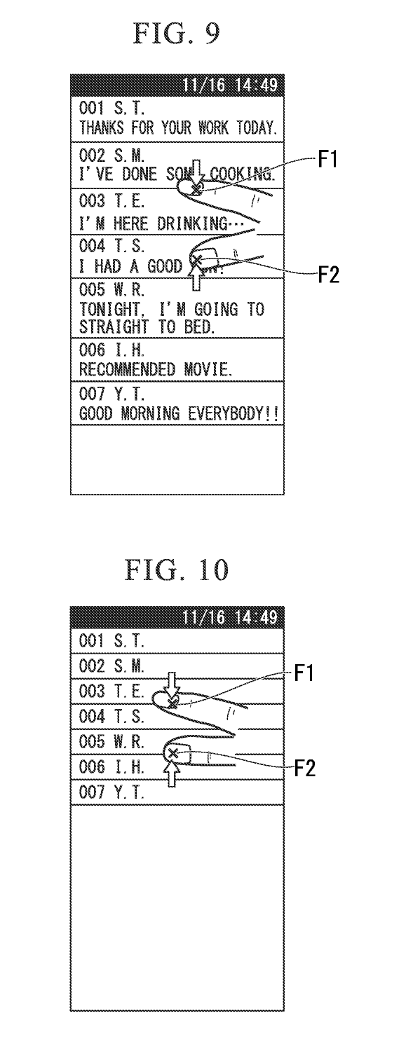

The example shown in FIG. 9 is a display example when the change amount Dn has become larger than the positive threshold α1. In this case, information up to one level lower than the case of FIG. 8 (levels 1 and 2) is displayed for each list item.

The example shown in FIG. 10 is a display example when the change amount Dn has become larger than the positive threshold α2. In this case, information that is the same as in FIG. 5 (level 1 only) is displayed for each list item.

In this manner, according to the present embodiment, at least two positions at which an operation input is accepted are detected and, regarding contents to be displayed in a region including the at least two detected positions, at least a part of the information amount of the contents to be displayed is controlled by the amount of change in distribution of the at least two positions. This, with regard to the contents specified by the input operation, changes the amount information displayed by the amount of change of the distribution of positions indicated by the operation input. For example, the amount of information to be displayed is increased by accepting a pinch-out operation, and the amount of information to be displayed is decreased by accepting a pinch-in operation. With a single operation, the amount of information is adjusted in a stepwise manner, in accordance with the amount of movement of the fingers. For this reason, the user can intuitively manipulate the amount of information of the displayed contents.

### Second Embodiment

Next, the second embodiment of the present invention will be described. Constituent elements that are the same as the above-described embodiment will be assigned the same reference symbols and the descriptions thereof will be adopted.

An electronic device 2 according to the present embodiment (not shown) has a display control unit 213 instead of the display control unit 113 in the electronic device 1 (FIG. 2).

The display control unit 213 performs the same processing as that of the display control unit 113. The display control unit 213 determines based on the distribution of positions indicated by the input position information from the position detection unit 111, which is one or the entire list item as the target of processing for changing the size of the display region. In this case, when the display region of one list item includes any position indicated by position information at the starting time of inputting position information, the display control unit 213 determines to perform processing as targeted for the one list item. In other cases, it determines to perform processing as targeted for the entire list item. In this case, when both of the minimum Y coordinate tu1 and the maximum Y coordinate tl1 based on the position information is larger than the upper-edge coordinate yk-1 of the list item Lk and is equal to or smaller than the lower-edge coordinate yk, the display control unit 213 determines to perform processing as targeted for the list item Lk. In other cases, the display control unit 213 determines to perform processing as targeted for the entire list item.

When the display control unit 213 determines to perform processing targeted for the list item Lk, as described above it controls the displayed hierarchal level number Nd regarding the only list item Lk in response to the change amount Dn. When the display control unit 213 determines to perform processing targeted for the entire item, it controls the displayed hierarchal level number Nd regarding the entire list item in response to the change amount Dn, as the same manner as the display control unit 113.

Additionally, the display control unit 213 may change the size of the display region regarding the entire list item immediately after changing the size of the display region regarding the one list item Lk. In that case, the display control unit 213 may fix (save) the displayed hierarchal level number Nd of the list item Lk and control the displayed hierarchal level number Nd of the remaining list item other than the list item Lk. Because the one list item Lk once changed the size of the display region may include information required by a user or information of much concern to the user, after that, by fixing the display region of the list item Lk, it is possible to maintain attention to the list item Lk.

(Example of Contents Display Processing)

Next, the contents display processing performed by the electronic device 2 according to the present embodiment will be described.

FIG. 11 is a flowchart showing the contents display processing according to the present embodiment.

The contents display processing according to the present embodiment has the same step as the contents display processing as shown in FIG. 4. The processing shown in FIG. 11, however, executes the step S205 after executing the step 104 (FIG. 4).

(Step S205) The display control unit 213 determines whether or not the list item Lk including the initial touch positions tu1, tl1 exists in the display region. If the determination is that there is no existing (NO at step S205), processing proceeds to step S105 (FIG. 4, the joining element A), control is performed for the displayed hierarchal level number Nd of the entire list. If the determination is that there is an existing (YES at step S205), processing proceeds to step S206.

(Step S206) The display control unit 213 determines the list item Lk in which it determined to be included in the display region to be the controlled item. After that, processing proceeds to step S105 (FIG. 4, the joining element A), and controlling of the displayed hierarchal level number Nd of list item Lk is done. That is, in the steps S120 to S123 (FIG. 4), the display control unit 213 controls only the displayed hierarchal level number Nd of list item Lk, contents not controlled by the other list item is displayed on the display 104.

(Contents Display Example)

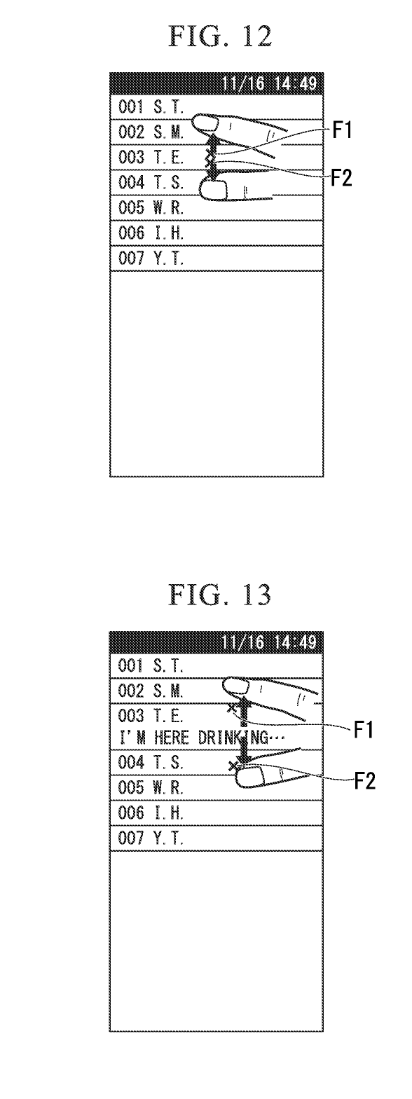

Next, the contents display examples will be described using FIG. 12 to FIG. 17.

FIG. 12 to FIG. 17 are drawings showing contents display examples (7) to (12), respectively.

Example shown in FIG. 12 indicates seven list items as the same as FIG. 5. This example shows that the any initial touch positions (representative points F1 and F2) are included in the display region of the list item 003. In FIG. 12, however, as the convenience of description, two fingers are shown in the position of distance from the representative points F1 and F2. In this case, the display control unit 213 determines the displayed hierarchal level number Nd as targeted to one list item 003 as a processing target. The arrows starting to the representative points F1 and F2 indicate to start broadening the spacing between the representative points F1 and F2.

The example shown in FIG. 13 is a display example when the change amount Dn is smaller than the negative threshold β1. In this case, information up to one hierarchal level greater than the example shown in FIG. 12 (levels 1 and 2) is displayed for the list item 003. However, the initial hierarchal level information (level 1) is displayed for the other list items.

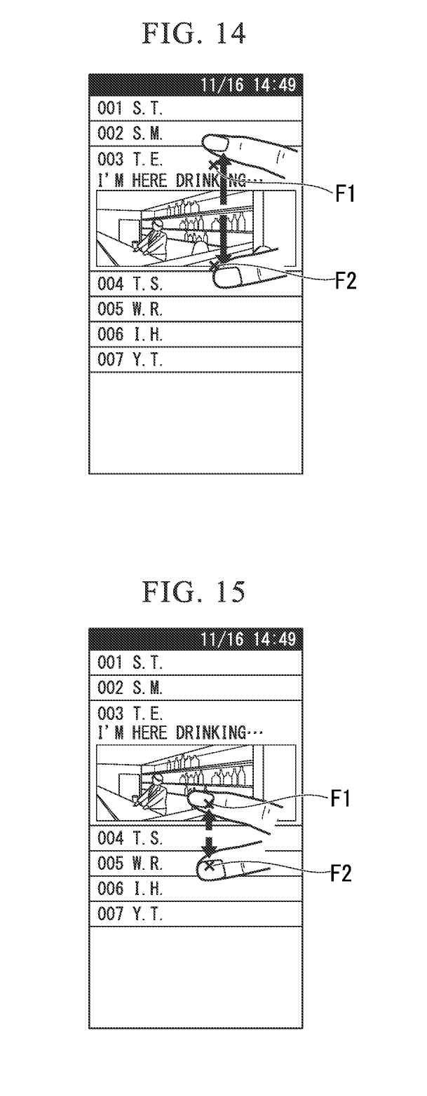

The example shown in FIG. 14 is a display example when the change amount Dn is smaller than the negative threshold β2. In this case, information up to two hierarchal levels greater than the example shown in FIG. 12 (levels 1 to 3) is displayed for the list item 003. In this case as well, the initial hierarchal level information (level 1) is displayed for the other list items.

In FIG. 15, the same type of contents is displayed as in FIG. 14. In this example, the representative points F1 and F2 are detected as the touch starting positions again and this indicates the start of movement to broaden the spacing thereof.

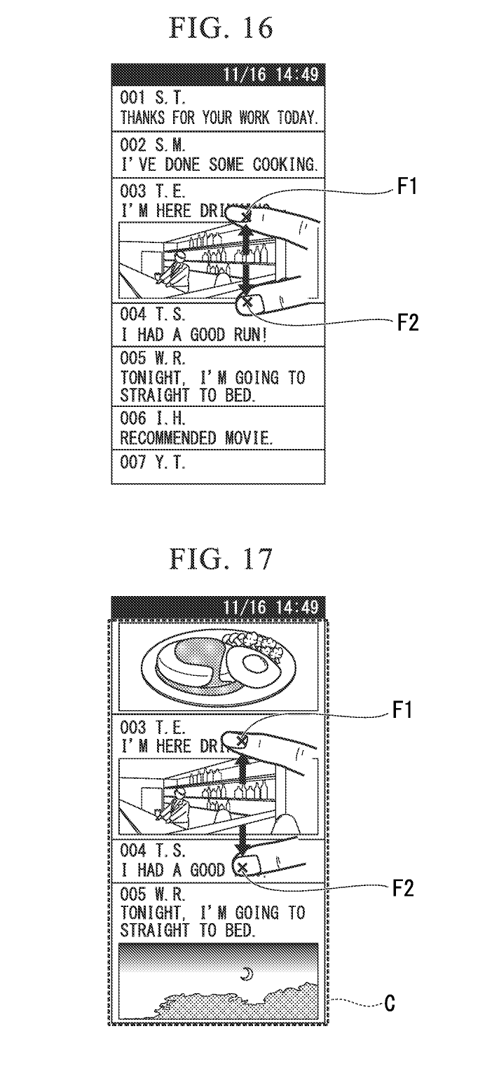

The example shown in FIG. 16 is a display example when the change amount Dn has become smaller than the negative threshold β1. In this case, information up to one level higher than the case of FIG. 14 (levels 1 and 2) is displayed for the entire list item other than the list item 003. Because the displayed hierarchal level number Nd of the list item 003 reaches to the upper limit, level 1 to 3 information is displayed as the same manner in FIG. 15.

The example shown in FIG. 17 is a display example when the change amount Dn is smaller than the negative threshold β2. Information up to two hierarchal levels greater than the case shown in FIG. 14 (levels 1 to 3) is displayed for the entire list item other than list item 003. In this example, a set of mutually neighboring list items 003 to 005, which includes the display region including the touch starting position, is displayed preferentially. On the other hand, the other list items, for example, a part of the list items 001 and 002, 006 and 007 exceed to the contents display region C so that the display 104 does not display them.

When the change amount Dn becomes larger than the positive threshold α1, the displayed hierarchal level number Nd is reduced for the entire list item as described using FIG. 8 to FIG. 10.

In the present embodiment, the absolute values such as the thresholds α1, α2, β1, and β2 for determining the reference hierarchal level number Pn with regard to one list item may be smaller than the absolute values, such as the thresholds α1, α2, β1, and β2 for the entire list item, respectively. This enables changing of the displayed hierarchal level number Nd by the movement of an operation actuator (for example a finger) smaller than the entire list item for one list item.

According to the above-described manner, according to the present embodiment, the number of hierarchal levels to be displayed is controlled for the list item to be displayed in the region including both of the at least two detected positions. Also, the present embodiment, if there is no list item including both of the at least two detected positions, controls the number of hierarchal level to be displayed for the entire list item included in contents.

This enables the user to intuitively select the target controlling the information amount to be displayed.

In the above-described embodiment, the examples in which the list items disposes in the Y direction and new hierarchal level information is added in the Y direction to broaden the display region, and the partial hierarchal level information is reduced to reduce the display region are described, however, this is not restricted. In the present embodiment, the direction in which the list items are arranged or the direction in which the display region is caused to be enlarged or shrunk may be the direction other than the Y direction, for example, the X direction.

Also, in the above-described examples, it has been described as the example in which the displayed hierarchal level number Nd is changed in response to a pinch-out operation and a pinch-in operation up until two levels at one time, the above-described embodiment is not restricted to this case. In the above-described embodiment, if the level number is N-1 level or smaller than N-1 level at one time (for example, 1 level), the displayed hierarchal level number Nd may be changed in response to the pinch-out operation and a pinch-in operation of any number of levels.

Also, in the above, although, as the change of distribution of at least two positions at which an operation input is accepted, mainly the pinch-in operation and the pinch-out operation have been described as examples, the present embodiment is not restrict thereto. In the present embodiment, for example, a broadening of distribution accompanying an increase in the number of positions at which an operation input is accepted or a narrowing of the distribution accompanying a decrease in the number thereof may be used. This enables control of the information amount of contents to be displayed by an increase in the number of operation actuators, such as fingers, contacting the touch sensor 103, for example, a change from two to three, or a decrease in the number of operation actuators, for example, a change from three to two.

The above-described embodiment can be executed in the following forms.
(1) An electronic device having, a display unit that displays contents including a plurality of list items, an operation input unit that accepts an operation input, a position detection unit that detects at least two positions at which the operation input unit accepts an operation input, and a display control unit that controls an information amount of contents to be displayed in a region including at least two positions detected by the position detection unit, based on the change amount of the distribution of the at least two positions.
(2) A contents display method in an electronic device that causes a display unit to display contents including a plurality of list items, the contents display method having a position detection step that detects at least two positions at which an operation input unit accepts an operation input, and a display control step that controls an information amount of contents to be displayed in a region including at least two positions detected by the position detection step, based on a change amount of the distribution of the at least two positions.
(3) The contents display method according to (2) wherein, at least one list item of the plurality of list items has information of a plurality of hierarchal levels, and the display control step controls the number of hierarchal levels to be displayed of the plurality of hierarchal levels, based on the change amount of the distribution.
(4) The contents display method according to (3) wherein, the display control step controls the number of hierarchal levels to be displayed for the list items to be displayed in a region including both of the at least two positions detected in the position detection step.
(5) The contents display method according to any one of (3) or (4) wherein, if there is no list item to be displayed in a region including both of the at least two positions detected in the position detection step, the display control step controls the number of hierarchal levels to be displayed for all list items included in the contents.
(6) A contents display program causing to implement, a computer of an electronic device that causes a display unit to display contents including a plurality of list items, a position detection procedure that detects at least two positions at which an operation input unit accepts an operation input, and a display control procedure that controls information amount of contents to be displayed in a region including at least two positions detected by the position detection procedure, based on a change amount of the distribution of the at least two positions.

According to the above-described (1), (2) and (6), contents specified by an operation input have a varying amount of information displayed, in accordance with a change amount of the distribution of positions indicated by an operation input. For this reason, a user can intuitively manipulate the amount of information of displayed contents.

According to (3), the number of displayed hierarchal levels is controlled by a change amount of the distribution of positions indicated by an operation input. For this reason, the amount of information displayed is adjusted in a stepwise manner with one operation in accordance with the distribution of positions at which an operation input was accepted.

According to (4), an item included at all positions indicated by an operation input is selected as the list item to be controlled and adjustment is made of the amount of information to be displayed for the selected item.

According to (5), the entire contents related to a position indicated by an operation input is selected, and adjustment is made of the amount of information to be displayed for the entire selected contents.

Parts of the electronic devices 1 and 2 in the above-described embodiments, for example, the control unit 110 may be implemented by a computer. In this case, they may be implemented by recording a program for implementing the control functionality into a computer-readable recording medium and by having a computer system read and execute the program recorded in the recording medium. The term “computer system” used here means computer system incorporated into the electronic devices 1 and 2, and includes an operating system and hardware such as peripheral devices. The term “computer-readable recording medium” refers to a removable medium such as a flexible disk, an optomagnetic disk, a ROM, a CD-ROM, or to a storage device such as a hard disk built into a computer system. Additionally, the term “computer-readable recording medium” may encompass one holding a program over a short time dynamically such as a communication line when a program is transmitted via a network such as the Internet or via a communication line such as a telephone line and one holding a program for a given period of time, such as a volatile memory within a computer system serving as a server or client. The above-noted program may be for implementing a part of the above-described functionality. Additionally, it may be one enabling implementation by combination with a program that already has recorded the above-noted functionality in a computer system.

A part or all of the electronic devices 1 and 2 according to the above-described embodiments may be implemented as an integrated circuit such as LSI (large-scale integration). Each of the functional blocks of the electronic devices 1 and 2 may be implemented by a processor separately or a part or all thereof may be implemented in integrated fashion as a processor. The method of integrated circuit implementation is not restricted to LSI, and implementation may be done by dedicated circuitry or a general-purpose processor. Additionally, in the event of the appearance of integrated circuit implementation taking the place of large-scale integration by advances in semiconductor technology, an integrated circuit using that technology may be used.

Although the foregoing has been a detail description of embodiments of the present invention, with references to the drawings, the specific constitution is not limited to the above, and may include various design modifications, within the scope of the spirit of the invention.

### INDUSTRIAL APPLICABILITY

The present invention can be applied to an electronic device, a contents display method, a contents display program and the like requiring intuitive manipulation of the amount of information of displayed contents.

### DESCRIPTIONS OF REFERENCE NUMERALS

1, 2 Electronic device
101 Enclosure
102 Touch panel
103 Touch sensor
104 Display
110 Control unit
111 Position detection unit
112 Image output unit
113, 213 Display control unit
114 Storage unit

1-6. (canceled)

7. An electronic device comprising:
a display unit configured to display contents, the contents including a plurality of list items;
an operation input unit configured to accept at least two operation inputs;
a position detection unit configured to detect at least two positions at which the operation input unit accepts the at least two operation inputs; and
a display control unit configured to control at least a part of an information amount of the contents to be displayed in a region including the at least two positions detected by the position detection unit, the control being performed based on a change amount of a distribution of the at least two positions.

8. A contents display method of an electronic device, the electronic device causing a display unit to display contents, the contents including a plurality of list items, the contents display method comprising:
detecting at least two positions at which an operation input unit accepts at least two operation inputs; and
controlling at least a part of an information amount of the contents to be displayed in a region including the detected at least two positions, the control being performed based on a change amount of a distribution of the at least two positions.

9. The contents display method according to claim 8,
wherein at least one list item of the plurality of list items has information of a plurality of hierarchal levels, and
in the control of the at least the part of the information amount, the number of hierarchal levels to be displayed of the plurality of hierarchal levels is controlled, the control of the number of hierarchal levels being performed based on the change amount of the distribution.

10. The contents display method according to claim 9,
in the control of the at least the part of the information amount, the number of hierarchal levels to be displayed for list items to be displayed in a region including both of the detected at least two positions is controlled.

11. The contents display method according to claim 9,
wherein, in a case that there is no list item to be displayed in a region including both of the detected at least two positions the number of hierarchal levels to be displayed for all list items included in the contents is controlled.
